(19) United States
(12) Patent Application Publication
(10) Pub. No.: US 2026/0348204 A1
(43) Pub. Date: Nov. 5, 2026

(54) Side-Door for a Motor Vehicle

(71) Applicant: Bayerische Motoren Werke Aktiengesellschaft, Muenchen (DE)

(72) Inventors: Steve BREUNINGER, Gauting (DE); Jacobo Dominguez OJEA, Muenchen (DE); Alexander SCHNEIDER, Muenchen (DE)

(21) Appl. No.: 19/111,854

(22) PCT Filed: Sep. 5, 2023
(86) PCT No.: PCT/EP2023/074244

§ 371 Date: Mar. 14, 2025

(30) Foreign Application Priority Data
Oct. 19, 2022 (DE) 10 2022 127 592.2

(51) Int. Cl. E05B 81/90; E05B 79/20; E05B 81/04

(52) U.S. Cl. CPC E05B 81/90; E05B 79/20; E05B 81/04

(57) ABSTRACT

A side-door for a motor vehicle has a side-door handle, a locking mechanism for locking the side door, and an emergency opening system which is connected to the opening mechanism and by means of which the opening mechanism can be operated manually. A user interface for actuating the emergency opening system is integrated in the side door handle.

### BACKGROUND AND SUMMARY

The present disclosure relates to a side door for a motor vehicle, and a motor vehicle having the side door.

In some modern motor vehicles, the side doors are no longer fitted with traditional side door handles, which mechanically unlock a side door lock by means of actuation of the side door by an operator, and instead side doors in which the side door lock is unlocked electromechanically are fitted. For example, on such side doors, a side door handle in the form of a winglet is formed, which serves merely as a grip aid for gripping or holding and pulling open the unlocked side door.

Such a configuration is disadvantageous when the side door is not supplied with electrical energy, i.e., the “de-energized state”. In this state, an emergency unlocking system is required which makes it possible to unlock the side door lock, and therefore open the side door of the motor vehicle, independently of the rest of the onboard electrical system of the motor vehicle.

This is achieved, for example, in motor vehicles, for example, via an external energy source or a mechanical solution with a Bowden cable attachment to the side door lock and an operator interface in the front wheel well of the motor vehicle.

WO2020239795A1 relates to an unlocking system for unlocking a vehicle door, having a locking system, of a vehicle. The unlocking system comprises an energy storage means, which is formed to provide the locking system with unlocking energy, with which the locking system can be switched from a locked state to an unlocked state, and also comprises an energy receiving means, which is connected to the energy storage means and is formed to receive electrical energy wirelessly from an energy source separate from the vehicle and to make it available to the energy storage means.

On the basis of this prior art, the object of the present disclosure is to provide a device which is suitable for enriching the prior art.

A specific configuration of the disclosure can achieve the object of optimizing the positioning of an emergency unlocking system for a side door of a motor vehicle and, in particular, a user interface of the emergency unlocking system.

The object is achieved by the features of the independent claim(s). The dependent claims relate to optional developments of the disclosure.

Accordingly, the object is achieved by a side door for a motor vehicle, wherein the side door comprises a side door handle, a locking mechanism for locking the side door, and an emergency opening system, which is connected to the opening mechanism and via which the opening mechanism can be operated manually. An operator interface for actuating the emergency opening system is integrated in the side door handle.

In other words, a side door, in particular an electric side door, will be provided, the locking mechanism or locking system of which is no longer required to be, or no longer is, mechanically actuated by a user to open the side door during normal operation of the motor vehicle, as is conventionally the case.

Such a side door can be referred to as an electric side door. This side door is equipped with an emergency opening system or an emergency unlocking system, which can be used by the operator in order to be able to unlock the locking system and therefore open the side door in a state in which the motor vehicle is unable to or does not provide any electrical energy for unlocking the locking system.

By actuating the emergency opening system, the locking mechanism of the side door is unlocked so that the side door can be opened. For this purpose, the emergency opening system comprises an operator interface which an operator can actuate, in particular in a mechanical manner, thereby unlocking the locking mechanism.

In contrast to conventional solutions, which propose to provide this interface in a wheel housing or a B pillar, i.e., external to the side door handle, it is proposed according to the disclosure that this user interface be integrated into the side door handle itself, which is both cost-effective and ergonomically advantageous.

In the following, optional developments of the side door described above are explained in detail.

The operator interface may comprise a flap which is integrated in the side door handle at a location accessible from the outside. By actuating the flap, the emergency opening system can be actuated and therefore the locking mechanism can be unlocked via the actuated emergency opening system.

The flap may be integrated in the side door handle in such a way that the emergency opening system can be actuated by displacing the flap.

The flap may be integrated in the side door handle in such a way that the emergency opening system can be actuated by rotating the flap.

The locking mechanism may comprise a side door lock which can be unlocked mechanically and/or electrically by actuating the emergency opening system, in particular the flap.

The flap may have a sensor which is configured to output a control signal for unlocking the side door lock to the locking mechanism when the flap is actuated. The sensor may be supplied with energy via an external energy source.

The flap may have a Bowden cable which is configured to unlock the side door lock when the flap is actuated. This may be implemented in such a way that the emergency unlocking procedure is triggered directly by actuating, in particular pulling of, the flap. Specifically, this may mean that the Bowden cable is attached to the flap. However, the disclosure is not limited to this arrangement. Rather, it is also contemplated that actuating the flap, in particular turning up the flap, exposes a loop, which is for example connected via the Bowden cable to the emergency opening system and can be pulled in a subsequent step to unlock the emergency opening system.

The side door handle may be designed in the form of a winglet. A winglet can be understood to be a component which is conventionally used in the aviation industry and projects outward beyond the motor vehicle side door in an upwardly or downwardly curved manner, and therefore represents a door handle recess which is shifted laterally outward and into which an operator can reach and thus hold the side door when opening or pulling open the latter.

The winglet may therefore have a substantially horizontally extending portion and a substantially vertically extending portion, wherein the vertically extending portion is located at a distance from an outer shell of the side door by the horizontally extending portion.

Formed between the vertically extending portion and the outer shell of the door, therefore, is a gap, which is referred to above as a door handle recess, is open to the front and rear and through which air can consequently flow along the outer shell of the motor vehicle when the motor vehicle is in motion. The winglet is therefore an aerodynamically advantageous configuration of a side door handle.

The side door handle may be arranged at the height of a beltline region of a side window of the side door and on a B pillar of the side door.

The above description can be summarized in other words as described in the following, with reference to a more specific configuration of the disclosure, wherein this description is not limiting in respect of the disclosure. The emergency opening mechanism, for example comprising a Bowden cable attachment, can be integrated directly into the winglet. This may take the form of a flap which is attached, for example, on the underside of the winglet. In particular, it is also contemplated to integrate this flap on the upper side of the winglet, for example so as to rotate or by means of a sliding mechanism. The flap could also be integrated so as to rotate or slide toward the front of the vehicle. Moreover, it is also contemplated to integrate a screen on the outermost surface in a motor vehicle width direction of the winglet. This screen could then be pulled off and would correspondingly pull a Bowden cable, which can be attached to the flap, in order thus to actuate the emergency opening mechanism. By pulling the cover or flap, it is possible to unlock the side door lock either mechanically or electronically in an emergency. This can be triggered either with the aid of a signal, for example by integrating a sensor in the cover, or purely mechanically, for example with a Bowden cable.

Furthermore, the disclosure relates to a motor vehicle, wherein the motor vehicle has a side door as described above.

The motor vehicle may be a passenger car, for example an automobile, and/or a commercial vehicle, such as a truck.

The above description in respect of the side door also applies analogously to the motor vehicle, and vice versa.

In the following, an embodiment is described with reference to the figure.

### BRIEF DESCRIPTION OF THE DRAWING

FIG. 1 schematically shows a perspective exterior view of a motor vehicle with an embodiment of a side door according to the disclosure, as seen along a motor vehicle longitudinal direction.

### DETAILED DESCRIPTION OF THE DRAWING

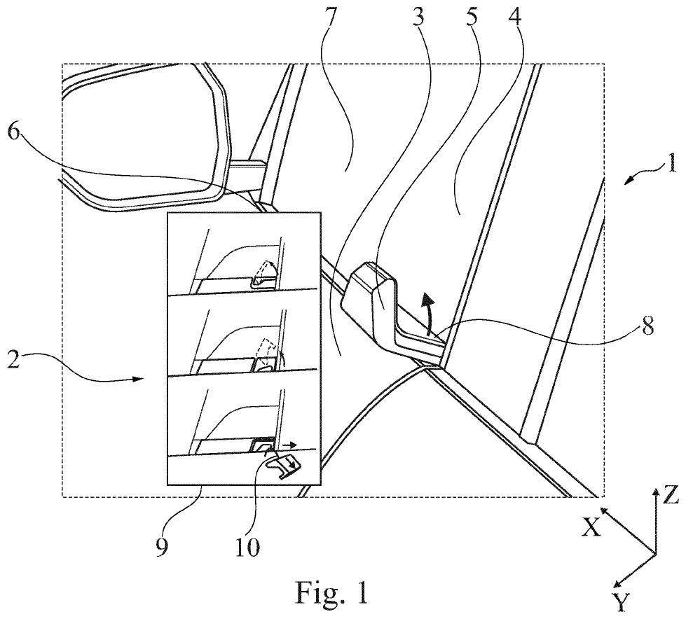

FIG. 1 depicts a Cartesian coordinate system having an X-axis, which extends from a rear to a front of a motor vehicle 1 and indicates a motor vehicle longitudinal direction X, a Y-axis, which indicates a motor vehicle width direction Y, and a Z-axis, which indicates a motor vehicle height direction Z. All axes X, Y and Z respectively enclose right angles with one another. The motor vehicle longitudinal direction X and the motor vehicle width direction Y span a substantially horizontal plane on which the motor vehicle height direction Z, which extends substantially parallel to a vertical, is positioned perpendicularly.

FIG. 1 depicts a perspective view, from the outside, of a detail of the motor vehicle 1, which has a side door 2 with an outer shell 3, a B pillar 4, a beltline region 6 for a side window or a window pane 7 and a side door handle which is formed as a winglet 5 and is arranged at the height of the beltline region 6 and on the B pillar 4.

The side door 2 further comprises a locking mechanism for locking the side door 2 and an emergency opening system, which is connected to the locking mechanism and by means of which the locking mechanism can be manually operated or unlocked.

The locking mechanism itself is arranged in the side door 2 and is therefore not depicted in the exterior view in FIG. 1. The same applies to the emergency opening system, with the exception of an operator interface and a merely schematically indicated Bowden cable 10 of the emergency opening system.

More precisely, the emergency opening system has an operator interface designed as a flap 8, which is integrated into the winglet 5 at a location accessible to a user from the outside, in this case from the rear, and which is mechanically connected to a door lock of the locking mechanism via the Bowden cable 10.

As depicted in box 9 in FIG. 1 for explanatory purposes only, and as indicated by the arrow on the flap 8, in order to unlock the side door 2 in an emergency, the user can rotate the flap 8 upward and then pull on the flap 8 in order thus to unlock the door lock of the locking mechanism via the Bowden cable 10 and therefore unlock the side door 2.

The disclosure is not limited to a rotational movement of the flap 8, and other solutions are also possible, in which the flap 8 is, for example, displaced along the winglet 5, in addition to or as an alternative to rotation.

Moreover, the disclosure is not limited to a purely mechanical solution. Rather, it is possible to provide, in particular, a mechatronic solution in which the actuation of the flap 8 by the user is detected, for example, via a sensor attached to the flap 8, and the side door lock is subsequently unlocked electrically via a control signal.

### LIST OF REFERENCE SIGNS

1 motor vehicle
2 side door
3 outer shell of the side door
4 B pillar of the side door
5 winglet
6 beltline for side window
7 side window or window pane
8 flap
9 schematic depiction of the operating principle of the emergency opening system
10 Bowden cable of the emergency opening system
X motor vehicle longitudinal direction
Y motor vehicle width direction
Z motor vehicle height direction

1.-10. (canceled)

11. A side door for a motor vehicle, comprising:
a side door handle;
a locking mechanism for locking the side door; and
an emergency opening system, which is connected to the locking mechanism and by which the locking mechanism is operable manually; and
an operator interface for actuating the emergency opening system, the operator interface being integrated in the side door handle.

12. The side door according to claim 11, wherein
the operator interface comprises a flap which is integrated in the side door handle at a location accessible from an exterior of the vehicle.

13. The side door according to claim 12, wherein
the flap is integrated in the side door handle such that the emergency opening system is actuatable by displacing the flap.

14. The side door according to claim 12, wherein
the flap is integrated in the side door handle such that the emergency opening system is actuatable by rotating the flap.

15. The side door according to claim 11, wherein
the locking mechanism comprises a side door lock which is unlockable mechanically and/or electrically by actuating the emergency opening system.

16. The side door according to claim 15, wherein
the flap comprises a sensor which is configured to output a control signal to the locking mechanism for unlocking the side door lock when the flap is actuated.

17. The side door according to claim 15, wherein
the flap comprises a Bowden cable which is configured to unlock the side door lock when the flap is actuated.

18. The side door according to claim 11, wherein
the side door handle is configured as a winglet.

19. The side door according to claim 11, wherein
the side door handle is arranged at a height of a beltline region of a side window of the side door and on a B pillar of the side door.

20. A motor vehicle comprising a side door according to claim 11.
